(19) United States
(12) Patent Application Publication
(10) Pub. No.: US 2016/0292750 A1
(43) Pub. Date: Oct. 6, 2016

(54) Process and system for determining the quality and condition of real property

(71) Applicant: Michelle Ritter, Fremont, CA (US)

(72) Inventor: Michelle Ritter, Fremont, CA (US)

(21) Appl. No.: 14/545,157

(22) Filed: Mar. 31, 2015

(51) Int. Cl. G06Q 30/02; G06Q 50/16

(52) U.S. Cl. CPC G06Q 30/0278; G06Q 50/16

(57) ABSTRACT

A process for determining a rating for the quality and condition of real property which comprises formulating a quality model and a condition model for the real property, and determining, based on the quality and condition models, a rating for the quality and condition of the real property. A non-transitory computer-readable medium is provided comprising encoded instructions for execution by one or more processors of a computer. The instructions when executed are operable to formulate a quality model and a condition model for the real property, and to determine a rating for the quality and condition of the real property. A system is provided comprising one or more processors and instructions encoded in one or more tangible media for determining a rating for the quality and condition of real property.

### CROSS-REFERENCE TO RELATED APPLICATION

This patent application is related to Provisional Patent Application having application No. 61/973,549, filed Apr. 1, 2014, inventor Michelle Ritter, entitled Appraising a Real Property; and fully incorporated herein by reference thereto as if repeated verbatim immediately herein. All benefits of the Apr. 1, 2014 filing date for the Provisional Patent Application is claimed.

### BACKGROUND OF THE INVENTION

1. Field of the Invention

Embodiments of the present invention relate generally to a process and system for evaluating real property. More particularly, embodiments of the present invention relate to a process and system for determining the quality and condition of real property.

2. Description of the Background Art

Real property is financially valuable in that such assets serve as investments for participants in the real estate market. Typically, when an institutional lender provides funds to a borrower, the borrower must prove and/or provide assets to ensure a sufficient equity (meaning the loan to debt ratio is sufficient collateral acceptable to the lender) in order to purchase a desirable property. The lender can gain utility from channeling available funds into a profitable investment (collecting up-front “points” from the borrower at 1% to 3% of the money loaned, a rate of interest that slightly exceeds the returns on non-real estate investments, a stream of revenue for the institutional lender's cash flow, etc.) and ultimately acquiring an acceptable return on and of investment. Market values of real property helps determine whether a loan is economically justifiable (i.e. that market vagaries have not affected loan to value ratios, etc.), and feasible (i.e., given the creditworthiness and financial strength of the potential borrower, etc.) Market value is typically determined by professional appraisals who take into account the quality and condition of the property.

Consequently, the accuracy of an appraisal is immensely critical, since the decisions of market participants are based on their expectations and understanding of the uses of a property and the resultant utility that the property will provide. Without standardized and objective market valuations, the entire real estate market and its interlocking relationships make for a very flimsy and vulnerable matrix which in its reliance on flawed market valuations may be precariously poised to collapse.

Appraisals may be done in a number of ways including, for example, personal inspection and analysis by a certified appraiser, who compiles data such as property improvements, site, location, square footage of improvements, number of bedrooms, type of foundation, and available utilities. The basic facts of the property and the appraiser's subjective ranking of the quality and condition of the subject property are then used, through various approaches, by the appraiser to arrive at a market value for the property.

While residential appraisals are generally more standardized than appraisals for other types of real property types, the current approaches used by appraisers to determine market values are inherently flawed because of variations in the basic descriptive attributes of properties and the subjective interpretations of these descriptive attributes. Consequently, market values, as determined in appraisals, are inherently inaccurate in that they are produced under the assumption that every appraiser will have applied the same set of “subjective” approaches and methods toward determining quality and condition.

However, the vague nature of the quality and condition categories still fosters subjectivity and appraiser bias when property quality and condition ratings are included. Unlike appraisals for residential property, appraisals of other types of property, such as commercial, agricultural, industrial, and mixed use, are non-standardized, and the ratings of quality and condition of property vary, depending on the appraisal format. Appraisal formats for non-residential properties typically allow for quality and condition to be rated similar to a Uniform Appraisal Dataset form, but with even fewer standardized definitions of categories. Or, even more subjectively, quality and condition can simply be described at the discretion of the appraiser. Consequently, the current lack of a truly standardized process, and system for substantially reducing subjectivity and/or bias is pervasive in real property appraisals, thereby making their conclusions suspect.

Given the lack of standardization in valuing the quality and condition of real property, the ambiguity of what those terms mean, and the blurred, very subjective distinctions between “very high quality” versus “exceptionally high quality,” for example, vitiates them as underpinnings of the appraisal. As an aside, there is currently no solution to accurately assessing the quality and condition of a property. And although home inspection companies can offer individual property assessments based on professional industry standards, zoning or other criteria set by government entities, there is no direct correlation between home inspection results and the mortgage industry in terms of real property quality and condition ratings. Thus, in order to make informed financial decisions regarding any given property, it is critical for market participants to not only know the present dollar value of the property, but the quality and condition of the property.

Consequently, what is needed and what has been invented is a process and system that quantifiably reduce, or even eliminate appraiser bias in determining the value of real property. The subject invention is intended to shore up one of the weakest, most common and most vulnerable components—market value bias—by stripping it of its subjectivity. What is further needed and what has been invented is a process and system which will allow for an accurate and systematic differentiation of real properties on the basis of the quality and condition of property-specific characteristics and attributes.

Ultimately, accurate and uniform quality and condition ratings will allow for: more precise collateral valuation, which can minimize risk and enhance internal cost allocations for lenders and other investors; reduce asymmetric information; allow tenants and property managers to better prepare and manage for forecasted maintenance and repairs; and perhaps even improve the quality of functional and aesthetic design in future properties, thereby enhancing the utility provided by real property.

### SUMMARY OF EMBODIMENTS OF THE INVENTION

Embodiments of the present invention provide a process for determining a rating for the quality and condition of real property comprising acquiring data pertaining to a subject real property; acquiring data pertaining general real property for subsequently determining the quality and the condition of the subject real property; and determining, with general real property data, coefficients on an asset type of the subject real property data. The process also includes processing the subject real property data, along with the coefficients on the asset type of the subject real property data, to establish at least one quality model and at least one condition model for the subject real property; and determining, based on the quality and condition model for the subject real property, a rating for the quality and a rating for the condition of the subject real property.

Embodiments of the present invention also provide a non-transitory computer-readable medium comprising encoded instructions for execution by one or more processors of a computer. The instructions when executed are operable to receive data pertaining to a subject real property; receive data pertaining general real property for subsequently determining the quality and the condition of the subject real property; and determine, with general real property data, coefficients on an asset type of the subject real property data. The instructions when executed are also operable to process the subject real property data along with the coefficients on the asset type of the subject real property data to establish at least one quality model and at least one condition model for the subject real property; and determine, based on the quality and condition models for the subject real property, a rating for the quality and a rating for the condition of the subject real property.

Embodiments of the present invention further also provide a system comprising one or more processors and instructions encoded in one or more tangible media for execution by one or more of the processors. The instructions when executed are operable to receive data pertaining to a subject real property; receive data pertaining general real property for subsequently determining the quality and the condition of the subject real property; and determine, with general real property data, coefficients on an asset type of the subject real property data. The instructions when executed are also operable to process the subject real property data along with the coefficients on the asset type of the subject real property data to establish at least one quality model and at least one condition model for the subject real property; and determine, based on the quality and condition models for the subject real property, a rating for the quality and a rating for the condition of the subject real property.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only and not by way of any limitation, wherein:

### BRIEF DESCRIPTION OF THE DRAWINGS

FIG. 1 is a broad exemplary block flow diagram for determining the quality (ratings) and condition (ratings) for Subject Property.

FIG. 2 is a more specific exemplary block flow diagram for determining QoP score (quality (ratings)) and CoP score (condition (ratings)) for Subject Property.

FIG. 3 is an exemplary block diagram for determining the Quality of Subject Property, and Condition of Subject Property, Models and Scores.

FIG. 4 is an exemplary system environment for providing the quality rating and condition rating of a designated Subject Property.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification may contain material which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A “computer” for purposes of some embodiments of the present invention may be any device having a processor. By way of example only, a “computer” may be a mainframe computer, a personal computer, a laptop, a notebook, a microcomputer, a server, or any of the like. By further way of example only, a “computer” is merely representative of many diverse products, such as by way of example only: pagers, cellular phones, handheld personal information devices, stereos, VCRs, set-top boxes, calculators, appliances, dedicated machines (e.g., ATMs, kiosks, ticket booths, and vending machines, etc.), and any other type of computer-based product, and so forth. A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. It is to be understood that a “computer” is not necessary for performing all procedural steps of embodiments of the present invention.

A “processor” includes a system or mechanism that interprets and executes instructions (e.g., operating system code) and manages system resources. More particularly, a “processor” may accept a program as input, prepares it for execution, and executes the process so defined with data to produce results. Thus, a processor is a system that is capable of “processing data” or general information. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “computer program” may be any suitable program or sequence of coded instructions which are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport a program (e.g., a computer program) for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory.

“Real property” for purposes of embodiments of the present invention includes the interests, benefits, and rights inherent in the ownership of physical real estate. Real property is both a physical commodity and the use of the real estate, so the supply of real estate in a market relates to the usability as well as the physical quantity of the available space. [See Paul F. Wendt, Real Estate Appraisal: Review and Outlook (Athens, Ga.: University of Georgia Press, 1974), pp. 4 and 29]. Consequently, those involved in real estate are primarily concerned with the supply of land suitable for a specific use, not simply the total number of acres available. For embodiments of the present invention, real property data is “general property” (“GP”) data that is relevant for the evaluation for any particular Subject Property (“SP”) dataset for the subsequent determination of the Quality and Condition of the particular Subject Property. GP data is not specific to any particular Subject Property, but is rather used for the purposes of evaluating the SP dataset or information.

“Real estate” is an identified parcel or tract of land, including improvements, if any. Real estate is immobile and tangible. The tangible components of real estate include: (a) land; (b) all things that are a natural part of land, such as trees and minerals; and (c) all things that are attached to land by people, such as buildings, building attachments (e.g., plumbing, electrical wiring, and heating systems), built-in items (e.g., cabinets and elevators), and site improvements. [Reference: The Appraisal of Real Estate, page 4]

An “appraisal” is the act or process of developing an opinion of value, or of the relative worth, of the asset(s). An appraisal of real property develops an opinion of value of the asset, wherein “a particular set of real property interests—not the real estate—is what is valued.” [Reference: The Appraisal of Real Estate, page 4]

“Utility” of real property refers to the ability of the property to satisfy a human need, want or desire. The effect of utility on value (of quality and condition) depends on the characteristics of the property. Utility of real property can often be categorized and measured in terms of: “functional utility” of the property and “aesthetic appeal” (or aesthetic utility) of the property. Considerations of utility, both functional and aesthetic, relate directly to the desirability of the property in the marketplace. Utility does not necessarily have to be considered in terms of functional utility and aesthetic appeal; rather, utility may consider other categories of utility, such as utility of design, accessibility or efficiency and sustainability.

“Functional utility” of real property is a measure of the property's ability to be useful and to perform and serve the function(s) for which it is intended, and refers to the utility provided by the character of the subject property's attributes. Function(s) may be classified as: primary or non-primary. Primary and non-primary functions vary depending on particular property use classifications. By way of example only, residential properties satisfy the need for shelter, commercial properties satisfy the need/desire for performing business activities, and agricultural properties satisfy the need/desire for sustaining mass-crop growing and production operations. For embodiments of the present invention, functional utility excludes any consideration of fundamental economic practices. Property attributes may concern improvements (such as the attributes of materials used on a roof and the type of construction implemented for the roof), assets (such as the efficiency of design and layout of a parking lot, or the size and type of rooms in an office building), and the property (such as the suitability of design and layout for the particular property use classification). [See: The Appraisal of Real Estate, page 259] The level of functional utility provided by the property is evaluated, given the type and use of the property, and according to current market preferences, standards, and expectations. [See: The Appraisal of Real Estate, page 220, 258]

“Aesthetic utility” of real property is a measure of the property's ability to be aesthetically appealing and refers to the utility provided by the character of the subject property's features. These features may be natural features, which are inherent and can not simply be added to the property (such as a 360-degree view) or design features, which are added to the property via the property's asset configurations and improvements (such as a pool). Design features may be evaluated in terms of form and ornamentation. By way of example, in determining the aesthetic utility of a building structure, a design feature appropriate for evaluation is the building's “architectural style,” or the character of the building's form and ornamentation as produced by the building design and construction. [Reference: The Appraisal of Real Estate, page 220, 256] The level of aesthetic utility provided by the property is evaluated, given the type and use of the property, and according to current market preferences, standards, and tastes. [See: The Appraisal of Real Estate, page 258]

Functional utility and aesthetic utility each differ across property use classifications, in terms of significance. For example, for an agricultural property, functional utility, derived largely from land improvements (e.g., irrigation systems and energy sources) and land characteristics (e.g., soil type), may be assigned significantly more significance (in the form of the coefficients in the models) than aesthetic utility, such as view. In contrast, for a residential property, functional utility, derived largely from building improvements and building characteristics, may be assigned only slightly more significance than aesthetic utility, such as view.

Practice of various embodiments of the present invention enable a real estate market participant to determine an indication of a “quality” of a provided property, and an indication of the “condition” of the provided property. “Quality” refers to ‘the features that make something what it is’ and ‘characteristic elements or attributes’ . . . [i]n relationship to an improvement, the quality is the materials used and the workmanship used to install the material.” (See: Appraisal Institute UAD Aftereffects: Efficiency vs. Obligation, p 4-81, Heyn, Molitor-Gennrich, LLC, 2012, Appraisal Institute.) “Design” and “quality” are essentially inseparable. On a certain level, quality is designed into rather than added onto a dwelling.

There are four primary elements of design: (a) function, or fitness of intended use, (b) visual appeal, (c) emotional appeal, (d) value. Good function (and fitness of intended use) and visual appeal are the primary drivers of quality. How well or how poorly function executes and the effectiveness of visual appeal has an impact on emotional appeal, and value.

“Quality” is a function of current times, such as the date of installation, and can change over time as building designs and materials change with time. Thus, when one says an appearance of a room in a building is “dated,” the meaning is that the material or utilities (e.g., kitchen cabinets or appliances) in the room are not the latest design or quality. “Condition” refers to the state of being, i.e., the improvement's physical state. Condition can also change over time as the state of a physical being is impacted with time and usage.

Indications of a “quality” and “condition” of a provided property for purposes of the present invention take the form of a score representation. A score representative of the quality of a property will here after be referred to as Quality of Property (QoP) Score, and a score representative of the condition of a property will here after be referred to as Condition of Property (CoP) Score.

The QoP Score is a measure of the “standard” to which a given subject property having particular assets and characteristics, is “useful.” Usefulness is evaluated on the basis of “utility,” such as functional utility and/or aesthetic appeal. The CoP Score is a measure of the “state” of the given subject property's “remaining usefulness,” at a particular point in time. Remaining usefulness is any usefulness remaining that is not provided by the QoP Score.

As will be further explained hereafter, a computing platform for various embodiments of the present invention determines the QoP and CoP scores based on models, and then scales each of the scores into a range of 300 to 850. A low score (i.e., QoP Score=300 or CoP Score=300) indicates that a property is of low quality or low condition, depending upon which score is being analyzed. A high score (i.e., QoP Score=850 or CoP Score=850) indicates that a property is of high quality or high condition, depending upon which score is being analyzed. Given these scores, market participants can make more educated financial decisions with respect to real property. Thus, a score is not an abstract indicator, but is a positive numeric indicator of quality and condition of an asset.

The following Table I is exemplary scores for QoP and CoP ranging from 300 to 850:

TABLE I
Quality/Condition (Q/C)
Analysis & Scoring

| QoP | CoP |
|---|---|
| Output | Output |
| 800-850 | 800-850 |
| 721-799 | 721-799 |
| 651-720 | 651-720 |
| 581-650 | 581-650 |
| 500-580 | 500-580 |
| 300-499 | 300-499 |

These outputs correspond to the established Uniform Standards of Professional Appraisal Practice, as outlined by the Uniform Appraisal Dataset (UAD) field-specific standardization requirements for “quality of construction” and “condition.”

For various embodiments of the present invention, a computing platform and a data processor are employed. The data processor is a computer-related system by which data can be saved, and various operations can be conducted. The computing platform may be implemented by: a general computer; a data processor activated by a stored computer program; or a specially constructed computing platform designed to conduct and complete the operations required for determining the quality and condition rating for any designated property. The computing platform may include a variety of components and systems, such as central processing unit(s), co-processor(s), memory, and other data processing devices and subsystems.

The coefficients (procedure for coefficient determination is explained hereafter) used in preferred embodiments of the present invention do not employ price figures (such as cost of replacement); thus price or cost figures are not needed to determine the coefficients. Weighing any variable (such as quality of foundation) based on price, such as price for improvement, is not necessary since the significance of the quality of any variable in the overall quality of the real property is not a matter of price, but rather takes into consideration the utility provided by the variable and various interactive factors (such as workmanship in installation and functional utility of design).

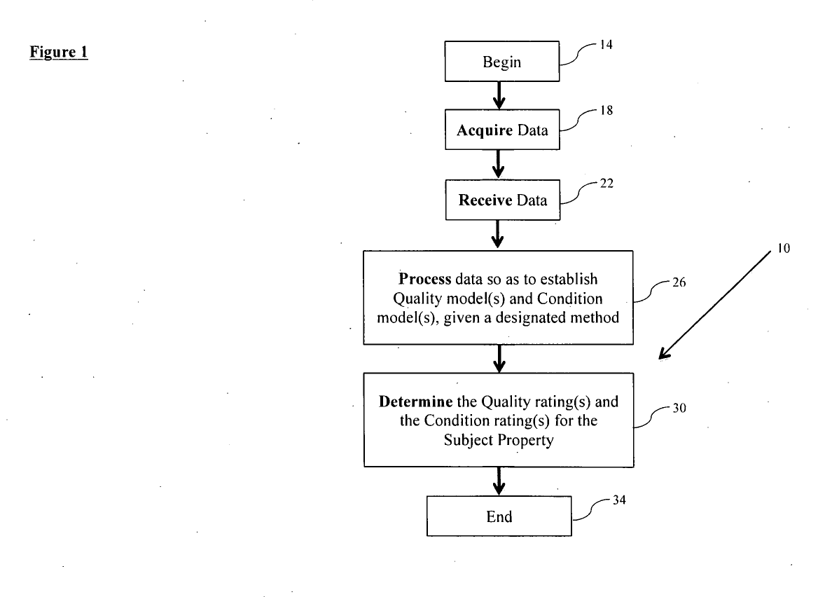

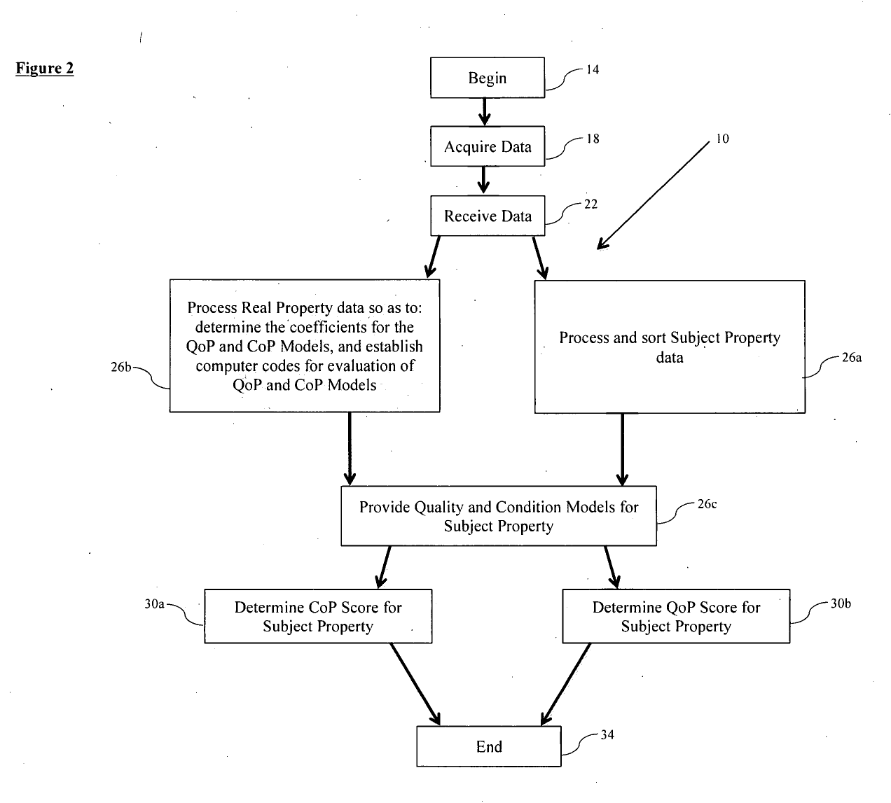

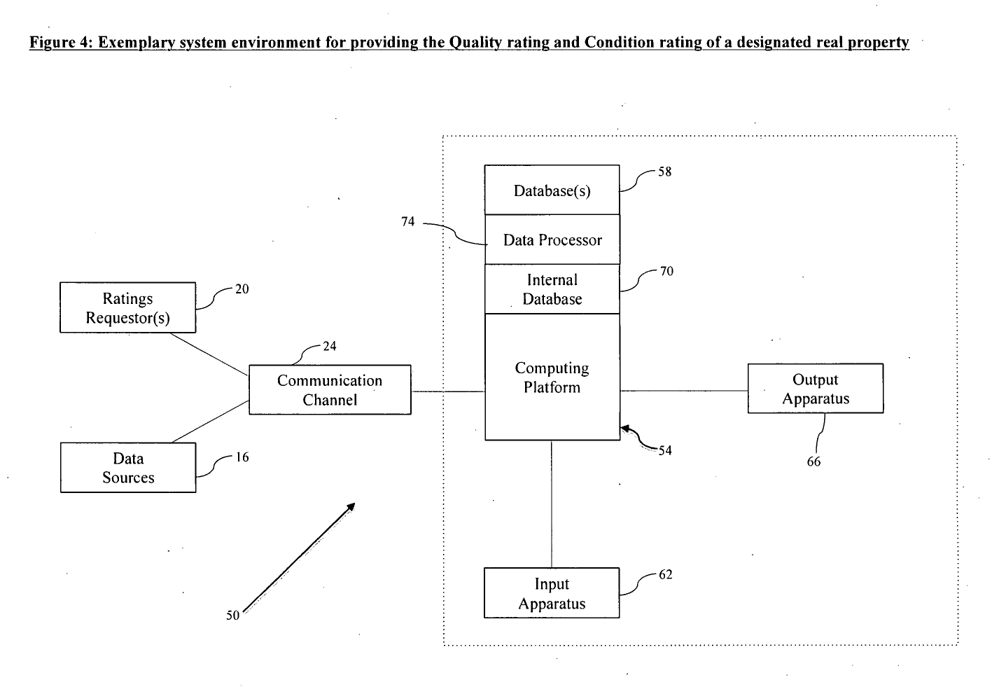

Referring now to the drawings for an exemplary illustration Of preferred embodiments for the present invention, there is seen exemplary block flow diagrams (each generally illustrated as 10 in FIGS. 1 and 2) for determining the quality (ratings/scores) and condition (ratings/scores) for SP. An individual or requester who wishes to obtain quality and condition ratings for SP begins, represented by block 14, by acquiring data, represented as block 18. The requester is represented by block 20 in FIG. 4. The data acquired (block 18) is designated subject property (“SP”) data and general property (“GP”) data.

Quality and condition ratings/scores are dependent on the acquisition of SP and GP data. Every time quality and condition ratings are to be determined for a designated SP, data specific to the designated SP must be acquired. However, data relevant to the evaluation of any given GP data does not necessarily have to be acquired each time determinations of quality and condition rating are made. GP data is not specific to any particular SP, but is rather used in the evaluation of a specific SP dataset.

The request for data is communicated to sources for data via a communication channel, blocks 16 and 24, respectively, in FIG. 4. The communication channel (block 24) is a single device or multiple cooperating devices that provide communication paths and may include direct cable connections, network connections (LAN, WAN, Ethernet, Intranet, Internet, wireless), and/or telephone network(s).

The data sources 16 are the sources for data, including data specific to SP and GP, which is utilized in the evaluation of the quality and condition of the SP. Sources for SP include, but are not limited to, property appraiser, property inspector, lender, owners, tenants/occupants, public records. Similarly, sources for GP include, but are not limited to, real property human experts (e.g., appraisers, contractors, assessors, and engineers); and providers of cost data, materials' properties, real estate performance and investment information, demographic information; and/or other data relevant for the evaluation of the SP.

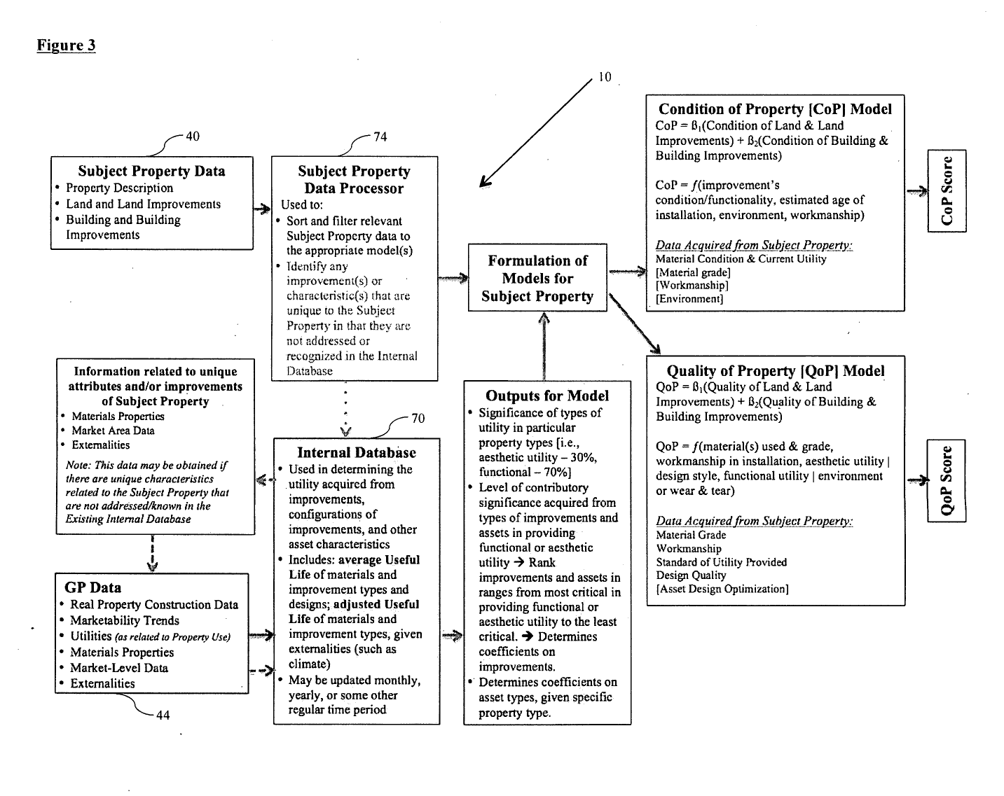

Block 40 in FIG. 3 represents SP data which is acquired data that is representative of a designated SP for which quality and condition are to be determined. In an embodiment of the invention, SP dataset includes (a) SP information; (b) data on improvements (e.g., land and building improvements); and (c) data on environmental characteristics of the SP land (e.g., any natural or man-made features that are contained in or affect the property).

SP dataset may be acquired by any suitable manner. Typically, acquisition of data pertaining to SP is obtained by a physical inspection of the SP. The individual inspecting the property may be an appraiser (certified for this type of scoring method) who records the desired data for the SP. If SP dataset information is recorded on paper, the individual inspecting the property will subsequently input the data into a processor (e.g. a lap type computer) which relays this physical acquired information to a main server. If the SP dataset information is recorded electronically into a processor, again the information may automatically be relayed to the main server.

SP dataset information comprises at least physical property address; property type and use classification; land (e.g. land having no improvements); land improvements; building; building improvements; and property description. SP dataset information may also include zoning; utilities; owner information; and occupancy information (demographic and socioeconomic characteristics of occupants, if applicable). In the spirit and scope of the present invention, when ever “SP dataset” is mentioned in the specification and claims, the SP dataset is to mean any dataset that is capable of producing a quality and condition for the designated (desired) SP in accordance with procedures described herein, and is not to be limited to any of the previously mentioned SP dataset information.

The following Table II is an exemplary list of SP data acquired by a physical inspection.

TABLE II
Property Description

| | | |
|---|---|---|
| Category: | Location | |
| Inputs: | Subject property physical | [Street number, Unit number (if applicable), Street name, City, |
| | address | USPS two-letter state or territory representation, zip code, |
| | | county, assessor's parcel #] |
| | Neighborhood | Select: Tract, Gated, Custom, Industrial Park, Retail Area |
| Category: | Property Use Type | |
| Inputs: | Property use classification | Select: Residential, Commercial, Industrial, Agricultural, Land, |
| | | Mixed Use, Special Use |
| | Type of occupancy and # | Options: (0-2), (3-5), (6-10), (11-25), (26-50), (51-75), (76-150), |
| | of regular-use occupants (if | (>150) |
| | applicable and if available) | |
| Category: | Property Area | |
| Inputs: | Site size | [Square footage (or acreage) of parcel] |
| | Site shape | Select: Roughly symmetric, asymmetric |
| | | Options: Rectangular, Circular, Triangular, Unique |
| | | Functional: utility, disutility, neutral |
| Category: | Utilities | |
| Inputs: | Electricity | Select: Present, Not Present |
| | Gas | Select: Present, Not Present |
| | Water | Select: Present, Not Present |
| | Irrigation (if applicable) | Select: Present, Not Present |
| | Sanitary sewer | Select: Present, Not Present |
| Category: | Zoning | |
| Inputs: | Regulations and | Required improvements to mitigate: flooding, earthquake |
| | requirements related to | damage, tornado damage |
| | pertinent natural hazards | Select: Present in Subject, Not Present in Subject |
| | (if applicable) | Functional: utility, disutility, neutral |
| | Number of units allowed | [# of units allowed; # of units on Subject Property] |
| | Lot coverage or floor area | [Lot coverage or FAR allowed; Lot coverage or FAR of Subject |
| | ratio (FAR) | Property] |

Utility inputs may be evaluated as binary variables, wherein the presence of a utility (such as electricity) would be denoted as 1 and the lack of presence of utility may be denoted as 0. However, for property types that may require unique amounts or types of a utility, the utility input(s) may be evaluated as categorical or numerical variables. For example, for agricultural or industrial properties, the “water” utility may be evaluated in terms of the presence of domestic water (i.e., water for human consumption) and of various types of raw or recycled water.

The following Table III is an exemplary list of land and land improvement SP data:

TABLE III
Land & Land Improvements

| Category: | Land Improvements | |
|---|---|---|
| Input: | Landscaping | Select: Present, Not Present |
| | Design Type | Select: Mediterranean, Japanese Garden, Cottage Garden, |
| | (if applicable) | Southwest, Formal, Tropical, Botanical, Energy-efficient, |
| | | Natural, Yard |
| | Quality of Design & | Select: Below Average, Average, Good - some unique elements, |
| | Installation | Excellent - highly unique |
| | (in terms of the nature & extent | |
| | of visual impacts and qualities, | |
| | given Property Type) | |
| | Type of degradation | Select: Poor - needs immediate rehabilitation (cost > $1000), |
| | | Below Average - obvious deferred maintenance ($1000 > cost), |
| | | Average - adequate condition, Well-maintained, Excellent |
| Input: | Property Barrier(s) | Installed (select all that apply): Fence, Gate, other (insert type), |
| | | none |
| | Type of Installed | Select: Wood, Aluminum, Vinyl, Chain Link, Farm, other |
| | Barrier(s) | |
| | Type of degradation | Select: Poor - needs immediate repair, Below average - obvious |
| | | deferred maintenance, Average - shows signs of natural wear- |
| | | and-tear, Good, Excellent |
| Input: | Parking | Select: Present, Not Present |
| | # of spaces available | [Insert Total #] |
| | Primary parking space | Select all that apply: Lightweight vehicles (passenger cars, |
| | users | pickup trucks, sport utility vehicles), Commercial trucks, |
| | | Farming Vehicles, Other |
| | Material(s) Used | Select all that apply: Asphalt, Concrete, Brick, Stone, Tile, |
| | | Wood, Earth materials (e.g., sand), Synthetics |
| | Quality of Construction & | Select: Below average, Average, Good, Excellent |
| | Installation | |
| | Design optimization | Functional: utility - no major areas of traffic, easy to access, |
| | | disutility - major traffic zones, adequate |
| | | (given # of spaces available, condition of materials, quality of |
| | | construction and functional need) |
| | Degradation of | Select: Poor - needs immediate repair, Below average - severe |
| | Material(s) Used: | cracks and deficiencies, Average, Good, Excellent |
| Input: | Drainage & Irrigation Systems | |
| | Type of System(s) | Select: Surface drainage, Subsurface drainage, None |
| | Signs of Deferred | Select: Yes-Significant, Yes-Some, No |
| | Maintenance | |
| | Design Features & Amenities | |
| Input: | Pool | Select: Present, Not Present |
| | Pool Type | Select: Above-ground, Fiberglass, Vinyl-lined in-ground, Gunite, |
| | | Other [insert type] |
| | Finish(es) | Select all that apply: Vinyl lining, Plaster, Tile, Fiberglass, |
| | | Other(s) [insert type(s)] |
| | Pool lighting | Select: Embedded incandescent fixtures, fiber-optics, other |
| | | lighting, none |
| | Quality of Pool Design & | Select: Basic, Standard, Good - some unique features, |
| | Construction | Excellent - highly unique |
| | Functionality of Pool | Select: Poor - needs replacement, Below average - needs |
| | Pump & Filter System | repair, Average, Good, Excellent |
| | Condition of Pool | Select: Poor - significant deferred maintenance (cost > 1000), |
| | | Below average - obvious deferred maintenance ($1000 > cost), |
| | | Average - adequate condition but some deferred maintenance, |
| | | Well-maintained, Excellent |
| Category: | Natural Characteristics of Land | |
| Input: | Utility of Soil type for | Select: Poor, Below Average, Average, Good, Excellent |
| | intended use | (Significant for agricultural producing operations as well as |
| | (if applicable) | industrial and commercial properties wherein the foundations of |
| | | buildings must have considerable load & bearing capacity) |
| Input: | View | Overall Aesthetic: Utility, Disutility, Neutral |
| | Presence of Obstructions | Select: Present, Not Present |
| | Type of Obstructions | Select: Power lines, limited sight, other |
| | (if present) | |
| | Condition of Aesthetic | Select: Short-Lived, Intermediate-Lived, Long-Lived |
| | Utility(View) | |
| Category: | Externalities | |
| | Access road(s) directly to | Select: Public Street, Private Street, Public Alley, Private Alley, |
| | the Subject Property | Other |
| | Traffic | Functional: Utility, disutility, adverse |
| | Traffic Volume | Select: Low, Mid, High |
| | Presence of pollutants | Select: Present, Not Present |
| | Type of pollutant(s) | Select all that apply: Noise, Smoke, Dust, Other |
| | Severity of Disutility | Select: None, Limited, Somewhat, Significant, Extreme |

The following Table IV is an exemplary list of building and building improvement SP data:

TABLE IV
Building & Building Improvements

| Category: | Building Description | |
|---|---|---|
| Input | Use Classification | Select: Residential, Office, Retail, Industrial, |
| | | Mixed Use, Agricultural, Special Use |
| Input | Layout | Select: [Room/Space Type] & Insert: [Total # of |
| | | such Rooms/Spaces] |
| Category: | Size (in square feet) | |
| Input | Gross building area (GBA) | [Insert square footage] |
| | [Total floor area of a building, measured from | Note: Particularly relevant for evaluation of |
| | the exterior of the walls: includes | single-unit residential property. |
| | superstructure & substructure] | |
| Input | Gross living area (GLA) | [Insert square footage] |
| | [Total area of finished, above-grade | Note: Particularly relevant for multifamily |
| | residential space: includes only finished, | properties and for industrial buildings. |
| | habitable living space] | |
| Input | Gross leasable area (GLA) | [Insert square footage] |
| | [Total floor area designed for the occupancy | Note: Particularly relevant for retail centers. |
| | and exclusive use of tenants: includes | |
| | mezzanines and basements] | |
| Category: | Exterior Materials & Design | |
| Sub- | Substructure-Foundation | |
| Category: | | |
| Input | Foundation Type | Select: Slab, Crawl Space, Full Basement, |
| | | Partial basement, Other |
| | Deferred Maintenance | Select: None; painting; weatherproofing; |
| | | waterproofing; dryrot; cracking |
| | Condition of Foundation | Select: Good; settling cracks; needs repair; |
| | | structural integrity impacted |
| Input | Basement Size (if applicable) | [Insert Square Footage] |
| | Wall Material | Select: [wall material] |
| | Interior Basement Entry | Select type, if applicable |
| | Exterior Basement Entry | Select type, if applicable |
| | Condition of Basement | Select: |
| Sub- | Superstructure | |
| Category: | | |
| Input | Roof & Drain System | Select: |
| | Roof Surface Material(s) | Select: |
| | Gutter/Downspouts Material | Select: |
| Input | Insulation | Select: |
| Input | Exterior walls | Select: |
| Input | Exterior doors | Select: |
| Input | Windows (storm windows and screens) | |
| | Window Type | Select: Single, Dual-Pane |
| | Weather-proofing | Select: Yes, No |
| Input | Amenities and special features | |
| | Deck | Select: Present, Not Present |
| | Balcony | Select: Present, Not Present |
| | Garage | Select: Attached, Detached, Built-in, Carport |
| Category: | Interior Description | |
| Input | Flooring | |
| | Floor coverings | List: [Location] & Select: [Type of Floor |
| | | Covering(s) in Location] |
| Input | Painting and finishing | |
| Category: | Mechanical & Electrical Systems | |
| Input | Heating and Cooling | |
| | Heating Type | Select: Forced Warm Air, Radiant, Electric |
| | Air Conditioning | Select: Present, Not Present |
| | Fireplace(s) | Select: Present, Not Present |
| Category | Externalities | |
| Input | Presence of pollutants | Select: Present, Not Present |
| | Type of pollutant(s) | Select all that apply: Noise, Smoke, Dust, Other |
| | Severity of Disutility | Select: None, Limited, Somewhat, Significant, |
| | | Extreme |

Block 44 in FIG. 3 represents GP (general real property) data which is acquired (typically by physical inspection or research) data and refers to data that is relevant for the evaluation of any particular SP dataset and for the subsequent determination of the quality and the condition of the particular SP. The GP datasets at least includes materials data (such as rate of depreciation, useful life expectancy, materials properties, such as load capacity, durability, appearance, maintenance); construction data (such as: building codes, standards, and regulations; and construction technology); profiles and trends (such as: construction—design trends, technology profiles; market—desirability trends); geographic data (topographical data, such as soil types and qualities); and environmental data (such as the climate of a particular region). In the spirit and scope of the present invention, when ever “GP dataset” is mentioned herein and in the claims, the GP dataset is to mean any dataset that is capable of producing a quality and condition of SP in accordance with procedures described herein, and is not to be limited to any of the previously mentioned GP dataset information

After SP and GP data is acquired (see block 18 in FIGS. 1 and 2) the data is transmitted by a communication channel (block 24) to a processor, generally illustrated as 50 in FIG. 4, where it is received (see block 22 in FIGS. 1 and 2). In a preferred embodiment of the invention, the processor 50 includes a computing platform 54, database(s) 58, input apparatus 62, and output apparatus 66.

The database(s) 58 store datasets in a data processor 74 as best shown in FIG. 3. Database(s) 58 includes dataset(s) specific to SP (i.e., the designated SP for which quality and condition ratings are to be determined) and dataset(s) acquired for the evaluation of SP data.

In an exemplary schematic, the database 58 is representative of an internal database (block 70 in FIG. 3) in that it is located within the computing platform 54, which is all part of the processor 50, as best shown in FIG. 3. However, the database 58 does not necessarily have to be internal; rather, the database(s) 58 may be located in multiple locations and connected to the computing platform 54 via direct links or networks.

Input apparatus 62 comprises one or more of the following: (a) input device(s), such as a keyboard, mouse, disk drive, telephone, and/or any other device for receiving and/or providing info to computing platform; (b) storage device (s), such as a random access memory (RAM) device, magnetic storage device, and/or any other device that can provide storage; and (c) network interface, which may enable connection to an Ethernet network, Internet protocol network, telephone network, and/or any other network capable of being connected to the input apparatus 62. The network interface allows for the exchange of data between the communication channel 24 and computing platform 54 as well as the input apparatus 62 and computing platform 54.

The output apparatus 66 may be used to provide quality rating(s) and condition rating(s) to requestor(s) 20 and/or to provide quality model(s) and condition model(s) to one or more of the following: (a) computing platform 54; (b) requestor 20; (c) processor 50; (c) computer display(s) (e.g. display screens) by which outputs from the computing platform 54 may be viewed or displayed; (d) printer device(s); (e) network interface which may enable connection to an Ethernet network, Internet protocol network, telephone network, and/or any other network capable of being connected to the output apparatus 66. The network interface allows for the exchange of data between the communication channel 24 and computing platform 54 as well as the output apparatus 66 and computing platform 54.

The processor 50 broadly processes data so as to establish quality model(s) and condition model(s), given a designated method (see block 26 in FIG. 1). In a preferred embodiment, the designated method is the “regression model” identified hereafter. The processor 50 more specifically includes a SP data processor 74 (see FIG. 3) which processes and sorts SP data, as represented by block 26a in FIG. 2. Processor 74 also identifies any improvement(s) or characteristic(s) that are unique to the SP in that they are not addressed or recognized in the internal database 70.

Processor 50 also processes GP data so as to determine the coefficients for the Quality model(s) and Condition model(s) and establish computer codes for evaluation of Quality model(s) and Condition model(s) (see block 26b in FIG. 2), and subsequently provide quality model(s) and condition model(s) for SP as represented by block 26c in FIG. 2. Based on the Quality and Condition models for SP, the Quality and Condition rating(s)/scores for the SP are determined, as represented by block 30 in FIG. 1 and blocks 30a and 30b in FIG. 2. The process ends (see block 34 in FIGS. 1 and 2) after the Quality and Condition models for the SP have been determined.

### GP Database Functions:

GP technical data is permanently saved onto internal database (block 70 in FIG. 3) in order to: (a) determine the weights of each utility type (e.g., functional utility and aesthetic utility); (b) obtain and identify the coefficients (i.e., βs) on improvements and features; (c) establish “bounds” and “rules” for ranking improvements and features; and (d) rank the improvements and features.

### (a) Determining the Utility Weights:

Given a particular property use classification, the utility types relevant to the subject property may be weighted. The weight associated with a particular utility type, for a given property use classification, may be predetermined. The numerical, contributory significance of a particular utility type is established based on how critical that type of utility is in ensuring that the property serves its intended purpose(s), given the particular use classification. Because the functional utility of the property inherently measures the capacity of the property to perform and serve its primary and secondary functions, functional utility is assigned a larger weight. Let the utility weight (UW) assigned to function utility equal (∂) and to aesthetic utility equal (1−∂), for a given property use classification.

### Example

| | |
|---|---|
| Property Use Classification: | Single-family residential (SFR) |
| Relevant Utility Types: | Functional utility |
| | Aesthetic utility |
| Primary functions of SFR: | Provide shelter |
| | Provide adequate access to shelter |
| Secondary functions of SFR: | Enhance and efficiently optimize livability, |
| | comfort, safety and security |
| Predetermined Weights for | .70 = ∂ for functional utility |
| Utility Types: | .30 = (1-∂) for aesthetic utility |

Predetermination of the contributory significance level of a particular type of utility for a given property Use Classification is one method for defining the coefficients for the improvements and features contributing to that type of utility. Other methods include statistical and regression techniques, such as logistic and probability regressions, that could allow the contributory significance level of a particular type of utility to be a function of property size, as well as the general property Use Classification.

### (b) Obtain and Identify Coefficients on Improvements and Features:

Improvements and features, which include natural features (such as view) and design features (such as floor plan layout and space optimization), can naturally be divided by where they are attached and/or directly affect (i.e., building or land). Thus, improvements and features would be divided with respect to their asset location. Then, within a particular asset location, improvements and features will be ranked whether they provide functional utility and/or aesthetic utility.

Each property improvement and feature is placed into the range that represents how critical that improvement or feature is in providing functional utility and, into another range that represents how critical this improvement or feature is in providing aesthetic utility. The placement of each improvement and feature in the two ranges is previously determined internally—relying on construction, materials, utility, etc. data from outside sources.

Then, given a particular number of total ranking levels, say four (4) levels that improvements and features could fall into, depending on how significant they are in supplying functional (or aesthetic) utility, each of the ranking levels is given a particular numerical amount to divide amongst the improvements and features within that category. Note that in categorizing improvements and features, the distribution of the improvements and features must be approximately normal across the levels.

The aggregate weight provided to a level may follow the formula:

$$AW {𝓁}_{i} = [ UW ] ( \frac{{𝓁}_{i}}{\sum {𝓁}_{i} + … + L} ) ,$$

where AWlᵢ is the Aggregate Weight for levelᵢ, lᵢ is the lowest level for which the improvements and features affect the utility for the particular asset type, L is the highest level for which the improvements and features affect the utility for the particular asset type, and UW is the weight for the particular type of utility. For functional utility, UW is (∂) and for aesthetic utility, UW is (1−∂).

By way of example, consider a set of improvements and features to be categorized into four (4) levels for functional utility and four (4) levels for aesthetic utility. Assume that the highest level is represented by the highest number (i.e., if there are four levels total, level 4 is the most critical level and level 1 is the least critical level). Thus, L equals four (4).

Furthermore, assume that some improvements and features affect only one type of utility (e.g., foundation, a building improvement, affects only functional utility of a building and not aesthetic utility of a building). Subsequently, under this assumption, each type of utility for every asset type (building and land), one (1) of the four (4) total levels represents improvements and features that have coefficients equal to zero (0). [Note: This assumption is not required but it is generally more representative of how improvements and features interact with different types of utility in reality.] Thus, lᵢ equals two (2), since the lowest level (1) is negligible. Lastly, let the utility weight of functional utility (∂) equal 0.7 and the utility weight of aesthetic utility (1−∂) equal 0.3.

The following exemplary tables include categorized improvements and features that could be evaluated for a single-family residential property, and the aggregate weight level, represented as a decimal point term, for each level of a particular utility type.

| Levels | Functional Utility Ranking for Building | Functional Utility Ranking for Land | ${AWl}_{i} = [ UW ] ( \frac{{l}_{i}}{Σ {l}_{j} + ⋯ + L} )$ |
|---|---|---|---|
| 4 (Critically necessary to serve primary function-structural integrity and minimal building usefulness) | 1-Foundation 2-Exterior walls 3-Exterior doors 4-Roof | 1-Hardscape | $\begin{matrix}{AWl}_{4} = [ .7 ] ( \frac{4}{Σ 2 + 3 + 4} ) \\ {AWl}_{4} = 0.31111\end{matrix}$ |
| 3 (Remaining servers of primary function and critically important providers of secondary function(s)- expected to be in building; components can not easily be added/changed) | 1-Flooring and subflooring 2-Ceiling 3-Interior walls 4-Interior doors 5-Garage | 1-Drainage and irrigation systems | $\begin{matrix}{AWl}_{3} = [ .7 ] ( \frac{3}{Σ 2 + 3 + 4} ) \\ {AWl}_{3} = 0.23333\end{matrix}$ |
| 2 (Servers of secondary function-highly desirable for building usefulness; components may be more easily added/changed) | 1-Electrical and mechanical systems 2-Windows | 1-Barrier control 2-Landscape 3-Electrical and mechanical systems | $\begin{matrix}{AWl}_{2} = [ .7 ] ( \frac{2}{Σ 2 + 3 + 4} ) \\ {AWl}_{2} = 0.15556\end{matrix}$ |
| 1 | 1-Cabinetry | 1-Amenities | AWl₁ = 0.00000 |
| (Functional utility not | 2-Amenities | 2-View | |
| directly affected) | 3-Painting and | | |
| | finishing | | |
| | 4-View | | |
| Total inputs: | 16 | 7 | |

| Levels | Aesthetic Utility Ranking for Building | Aesthetic Utility Ranking for Land | ${AWl}_{i} = [ UW ] ( \frac{{l}_{i}}{Σ {l}_{j} + ⋯ + L} )$ |
|---|---|---|---|
| 4 (Significant visibility, large quantity of component, difficult to alter, inherently present in asset and/or highly expected in asset type) | 1-Exterior walls 2-Interior walls 3-Roof 4-Flooring and subflooring | 1-Landscape 2-Hardscape 3-View | $\begin{matrix}{AWl}_{4} = [ .3 ] ( \frac{4}{Σ 2 + 3 + 4} ) \\ {AWl}_{4} = 0.1333\end{matrix}$ |
| 3 (Visibility throughout, less quantity, moderately difficult to alter, and/or highly desirable in asset type) | 1-Flooring and subflooring 2-Ceiling 3-Interior walls 4-Interior doors 5-Garage | 1-Amenities | $\begin{matrix}{AWl}_{3} = [ .3 ] ( \frac{3}{Σ 2 + 3 + 4} ) \\ {AWl}_{3} = 0.1000\end{matrix}$ |
| 2 (Limited visibility, relatively easy to alter and/or limited provider of aesthetic utility) | 1-Interior doors 2-Garage 3-Electrical and mechanical systems 4-Windows | 1-Barrier control 2-Electrical and mechanical systems | $\begin{matrix}{AWl}_{2} = [ .3 ] ( \frac{2}{Σ 2 + 3 + 4} ) \\ {AWl}_{2} = 0.0667\end{matrix}$ |
| 1 | 1-Foundation | 1-Drainage and | AWl₁ = 0.0000 |
| (Aesthetic utility not directly | 2-HVAC | irrigation systems | |
| affected) | | | |
| Total inputs: | 16 | 7 | |

Note that the total sum of the aggregate weight levels from both functional utility and aesthetic utility equate to 100%, or 1.000.

Once the AWL is determined, the total number of components in levelᵢ are assigned a weight, which now represents their coefficient within the model, by the following:

$$IW {𝓁}_{i} = \frac{AW {𝓁}_{i}}{n}$$

where IWlᵢ is the individual Input Weight for levelᵢ in the specified utility type, and n is the total number of improvements and features (i.e., inputs) within levelᵢ.

The following exemplary tables include the individual input weight levels for the categorized improvements and features for each level of a particular utility type.

| Levels | Functional Utility Ranking for Building | Functional Utility Ranking for Land | Total number (n) of improvements and features in level | ${IWl}_{i} = \frac{{AWl}_{i}}{n}$ |
|---|---|---|---|---|
| 4 | 1-Foundation 2-Exterior walls 3-Exterior doors 4-Roof | 1-Hardscape | 5 | $\begin{matrix}{IWl}_{4} = \frac{0.31111}{5} \\ {IWl}_{4} = 0.06222 = {β}_{i , Level 4}\end{matrix}$ |
| 3 | 1-Flooring and subflooring 2-Ceiling 3-Interior walls 4-Interior doors 5-Garage | 1-Drainage and irrigation systems | 6 | $\begin{matrix}{IWl}_{3} = \frac{0.23333}{6} \\ {IWl}_{3} = 0.03889 = {β}_{i , Level 3}\end{matrix}$ |
| 2 | 1-Electrical and mechanical systems 2-Windows | 1-Barrier control 2-Landscape 3-Electrical and mechanical systems | 5 | $\begin{matrix}{IWl}_{2} = \frac{0.15556}{5} \\ {IWl}_{2} = 0.03112 = {β}_{i , Level 2}\end{matrix}$ |
| 1 | 1-Cabinetry | 1-Amenities | 6 | IWl₁ = 0.00000 = β_{i,Level 1} |
| | 2-Amenities | 2-View | | |
| | 3-Painting and | | | |
| | finishing | | | |
| | 4-View | | | |

| Levels | Aesthetic Utility Ranking for Building | Aesthetic Utility Ranking for Land | Total number (n) of improvements and features in level | ${IWl}_{i} = ( \frac{n}{{AWl}_{i}} )$ |
|---|---|---|---|---|
| 4 | 1-Exterior walls 2-Interior walls 3-Roof 4-Flooring and subflooring | 1-Landscape 2-Hardscape 3-View | 7 | $\begin{matrix}{IWl}_{4} = \frac{0.1333}{7} \\ {IWl}_{4} = 0.01905 = {θ}_{i , Level 4}\end{matrix}$ |
| 3 | 1-Cabinetry 2-Ceiling 3-Exterior doors 4-View 5-Painting and finishing 6-Amenities | 1-Amenities | 7 | $\begin{matrix}{IWl}_{3} = \frac{0.1000}{7} \\ {IWl}_{3} = 0.01429 = {θ}_{i , Level 3}\end{matrix}$ |
| 2 | 1-Interior doors 2-Garage 3-Electrical and mechanical systems 4-Windows | 1-Barrier control 2-Electrical and mechanical systems | 6 | $\begin{matrix}{IWl}_{2} = \frac{0.0667}{6} \\ {IWl}_{2} = 0.01111 = {θ}_{i , Level 2}\end{matrix}$ |
| 1 | 1-Foundation | 1-Drainage and | 2 | IWl₁ = 0.00000 = θ_{i,Level 1} |
| | | irrigation systems | | |

### (c) Establishing “Bounds” and “Rules” for Ranking Improvements and Features:

For any type of improvement and feature, the Real Property technical database will have applicable information, such as all possible methods of construction, materials that can be used, and which systems work better together for a particular environment. This data is available; it is simply not accumulated. Following the receipt of this data, rules would be established for each improvement and feature, which determines how we want to evaluate this improvement or feature in a particular type of real property.

### (d) Ranking the Improvements and Features:

Ranking systems will vary across different property types, wherein some improvements may provide higher levels of contributory significance in a particular property type and will subsequently rank higher than these same improvements would in rankings for other property types.

The ranking systems are established for all real property types (and are predetermined prior to specific subject property input) and may be updated monthly, yearly, or at some other regular interval. These updates may take into account new data trends (as they pertain to marketability, construction method, and/or property development), new construction technology, and/or other relevant factors that influence how critical an improvement is to providing a specified type of utility.

### Quality of Property [QoP]:

The Quality of Property (herein referred to as QoP) Score is a measure of the standard to which a given subject property, with its particular assets and characteristics, is useful, wherein usefulness may be evaluated on the basis of utility, such as functional utility or aesthetic appeal.

Σᵢ₌₁ⁿ(Quality of Assetᵢ)=Σᵢ₌₁ⁿ(Utilityⱼ of Assetᵢ)×(UWⱼ) 1]

### QoP=

where:
QoP is the Quality of Property
UWⱼ is the weight of utility type j in determining QoP
[Assuming that the set of Assets being evaluated are: Land and Building; and Utility can be divided into functional utility type and aesthetic utility type.]

$$2 ] QoP = QoL + QoB = ( \partial ) ( Functional Utility of Land ) + ( \partial ) ( Functional Utility of Building ) + ( 1 - \partial ) ( Aesthetic Utility of Land ) + ( 1 - \partial ) ( Aesthetic Utility of Building )$$

where:
Asset₁ is Land
Asset₂ is Building
QoL is the Quality of the Land asset type
QoB is the Quality of the Building asset type
∂ is the UW of functional utility
1−∂ is the UW of aesthetic utility

QoL=Σ(QoLI) 3₁]

where:
QoL is the Quality of Land Asset Type
Σ(QoLI) is the summation of the qualities of the land inputs (i.e., land improvements and features within the Land asset type).

QoB=Σ(QoBI) 3₂]

where:
QoB is the Quality of Building Asset Type
Σ(QoBI) is the summation of the qualities of the building inputs (i.e., building improvements and features within the Building asset type).

ΣQoLI=Σᵢ₌₁^{k}(Quality of Inputᵢ in Land asset type)×(βᵢ^{Func.U.})+(Quality of Inputᵢ in Land asset type)×(θᵢ^{Aesth.U.}) 4₁]

where:
ΣQoLI is the summation of the qualities of the inputs (i.e., improvements and features) within the Land asset type;
   βₗ is the coefficient (or 'weight) of a particular inputᵢ in a specific level for which the Land improvements and features were categorized and valued according to their provision of functional utility.
   θₗ is the coefficient (or 'weight) of a particular inputᵢ in a specific level for which the Land improvements and features were categorized and valued according to their provision of aesthetic utility.

ΣQoBI=Σᵢ₌₁^{k}(Quality of Inputᵢ in Building asset type)×(βᵢ^{Func.U.}′)+(Quality of Inputᵢ in Building asset type)×(θᵢ^{Aesth.U.}) 4₂]

where:
QoBI is the summation of the qualities of the inputs (i.e., improvements and features) within the Building asset type.
   βₗ is the coefficient (or 'weight) of a particular inputᵢ in a specific level for which the Land improvements and features were categorized and valued according to their provision of functional utility
   θₗ is the coefficient (or 'weight) of a particular input; in a specific level for which the Land improvements and features were categorized and valued according to their provision of aesthetic utility

Qoi=Q(Type∪Material(s) Used|Interactive Inputs∪Externalities)±Q(Design Optimization|Interactive Inputs∪Externalities) 5]

where:
Qoi refers to Quality of an individual Improvement.
Type refers to the particular type of improvement system or construction method used.
Material(s) Used refers to the particular material(s) used in/with the improvement. Based on the material(s) used, the material grade of an improvement, in a given property, refers to how effectively the improvement used compares to alternative options in serving a designated utility purpose or set of utility purposes.
Design Optimization refers to the extent to which the particular improvement's characteristics (e.g., construction method, layout) enhance utility. For example, functional utility of design for parking, a land improvement, would likely be a negative number subtracting from the QoI if the parking lot design created significant traffic issues within.
Interactive Inputs refer to any factors that affect the Quality analysis of the dependent variables (i.e., Type, Material(s) Used, Functional Utility of Design, Aesthetic Utility of Design). For example, the number of parking spaces available and the property use classification are interactive inputs that could be considered when determining the quality of Functional Utility of Design for parking.
Externalities refer to factors external to the property, which either positively or negatively affects the property's provision of utility. Positive externalities include: close geographic location to police and fire protection, and to highways; and appealing view of the surrounding neighborhood, city, or region. Negative externalities include: pollutants and excessive traffic congestion by the property.

### Nature of Quality:

Quality changes when the ranking orders of improvements and/or combinations of improvements change. Consequently, quality is a function of time in that new technological advancements can potentially cause a shift in rank of an improvement or a set of improvements. Because the quality of an improvement is valued, given the quality of workmanship and other influencing factors, technological advancements do not necessarily have to directly relate to the improvements themselves. Examples include: change in construction method that dramatically enhances the installation of the foundation or new lacquer that better seals and weatherproofs the roof. Because technological advancements typically require longer periods of time to occur, the Quality is rather inelastic across time. Therefore, the Quality Score for a particular property will likely remain relatively uniform across time, and only start to show a downward slope in the longer-run as new technologies become available. Nevertheless, there can be “shocks” to the Quality of a property, such as: significant remodeling/renovation or damage from a natural disaster.

### Condition of Property [CoP]:

The CoP Score is a measure of the state of the given subject property's remaining usefulness, at a particular point in time, with respect to physical capital assets and improvements that may depreciate across time. Unlike the evaluation and determination of QoP, the CoP only evaluates the physical elements of real property and determines those elements' physical state, or condition.

CoP=Σᵢ₌₁ⁿ(Condition of Assetᵢ)=Σᵢ₌₁ⁿ(Utilityⱼ of Assetᵢ)×(UWⱼ) 1]

where:
CoP is the Condition of Property
UWᵢ is the weight of utility type j in determining CoP
[Assuming that the set of Assets being evaluated are: Land and Building; and Utility can be divided into functional utility type and aesthetic utility type.]

$$2 ] CoP = CoL + CoB = ( \partial ) ( Functional Utility of Land ) + ( \partial ) ( Functional Utility of Building ) + ( 1 - \partial ) ( Aesthetic Utility of Land ) + ( 1 - \partial ) ( Aesthetic Utility of Building )$$

where:
Asset₁ is Land
Asset₂ is Building
CoL is the Condition of the Land asset type
CoB is the Condition of the Building asset type
∂ is the UW of functional utility
1−∂ is the UW of aesthetic utility

CoL=Σ(QoLI) 3₁]

where:
CoL is the Condition of Land Asset Type
Σ(CoLI) is the summation of the condition of the land inputs (i.e., land improvements and features within the Land asset type).

CoB=Σ(CoBI) 3₂]

where:
CoB is the Condition of Building Asset Type
Σ(CoBI) is the summation of the condition of the building inputs (i.e., building improvements and features within the Building asset type).

ΣCoLI=Σᵢ₌₁^{k}(Expected Condition of Inputᵢ in Land asset type−True Condition of Inputᵢ in Land asset type)×(βᵢ^{Func.U.})+Σᵢ₌₁^{k}(Expected Condition of Inputᵢ in Land asset type−True Condition of Inputᵢ in Land asset type)×(θᵢ^{Aesth.U.}) 4₁]

where:
ΣCoLI is the summation of the conditions of the inputs (i.e., improvements and features) within the Land asset type.
   βₗ is the coefficient (or 'weight) of a particular inputᵢ in a specific level for which the Land improvements and features were categorized and valued according to their provision of functional utility.
   θₗ is the coefficient (or 'weight) of a particular input; in a specific level for which the Land improvements and features were categorized and valued according to their provision of aesthetic utility.
   Expected condition of an input is the estimated state of that input at a particular time.
   True condition of an input is the actual state of that input in the Subject Property at a particular time.

ΣCoBI=(Expected Condition of Inputᵢ in Building asset type−True Condition of Inputᵢ in Building asset type)×(βᵢ^{Func.U})+(Expected Condition of Inputᵢ in Building asset type−True Condition of Inputᵢ in Building asset type)×(θᵢ^{Aesth.U.}) 4₂]

where:
ΣCoBI is the summation of the conditions of the inputs (i.e., improvements and features) within the Building asset type.
   βₗ is the coefficient (or 'weight) of a particular input; in a specific level for which the Building improvements and features were categorized and valued according to their provision of functional utility.
   θₗ is the coefficient (or 'weight) of a particular input; in a specific level for which the Building improvements and features were categorized and valued according to their provision of aesthetic utility.
   Expected condition of an input is the estimated state of that input at a particular time.
   True condition of an input is the actual state of that input in the Subject Property at a particular time.

To determine the condition of an input that can be evaluated in terms of age and useful life expectancy, for example, the true age and condition of the input at a particular time can be subtracted from the expected age and condition of the input. If the true age and condition is greater than the expected age and condition of the input, then the particular input has a higher condition than expected (i.e., longer useful life expectancy). If the true age and condition is less than the expected age and condition of the input, then the particular input has a lower condition than expected (i.e., shorter useful life expectancy).

By practice of embodiments of the present invention, there is an accurate assessment of the quality and condition of the SP's major components (i.e., variables included in the substructure, superstructure interior description, electrical and mechanical systems, exterior amenities, and external influences). Additionally, there is a greater precision amongst the quality and condition rankings or scores, as a direct result of accurate and thorough property assessment and extremely large data-base modeling, appraisal subjectivity differences are eliminated when assigning real property quality and condition rankings

Reference throughout the specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A process for determining a rating for the quality and condition of real property comprising:
(a) acquiring data pertaining to a subject real property;
(b) acquiring data pertaining general real property for subsequently determining the quality and the condition of the subject real property;
(c) determining, with general real property data, coefficients on an asset type of the subject real property data;
(d) processing the subject real property data, along with the coefficients on the asset type of the subject real property data, to establish at least one quality model and at least one condition model for the subject real property; and
(e) determining, based on the quality and condition model for the subject real property, a rating for the quality and a rating for the condition of the subject real property.

2. The process of claim 1 wherein said asset type of subject real property is selected from the group of asset types consisting of residential property, agriculture property, industrial property, and commercial property, or combinations thereof.

3. The process of claim 1 additionally comprising sorting the subject real property data.

4. The process of claim 1 additionally comprising updating the general real property data.

5. The process of claim 1 additionally comprising identifying any improvements that are unique to the subject real property.

6. The process of claim 1 displaying the rating for the quality and a rating for the condition of the subject real property.

7. A non-transitory computer-readable medium comprising encoded instructions for execution by the one or more processors of a computer, the instructions when executed are operable to:
(a) receive data pertaining to a subject real property;
(b) receive data pertaining general real property for subsequently determining the quality and the condition of the subject real property;
(c) determine with the general real property data, coefficients on an asset type of the subject real property data;
(d) process the subject real property data along with the coefficients on the asset type of the subject real property data to establish at least one quality model and at least one condition model for the subject real property; and
(e) determine, based on the quality and condition models for the subject real property, a rating for the quality and a rating for the condition of the subject real property.

8. The non-transitory computer-readable medium of claim 7 wherein said asset type of subject real property is selected from the group of asset types consisting of residential property, industrial property, agriculture property, and commercial property, or combinations thereof.

9. The non-transitory computer-readable medium claim 7 wherein the instructions when executed are additionally operable to:
sort the subject real property data.

10. The non-transitory computer-readable medium of claim 7 wherein the instructions when executed are additionally operable to:
receive updates on the general real property data.

11. The non-transitory computer-readable medium of claim 7 wherein the instructions when executed are additionally operable to:
receive improvement data that is unique to the subject real property.

12. The non-transitory computer-readable medium of claim 7 wherein the instructions when executed are additionally operable to:
display on a screen the rating for the quality and a rating for the condition of the subject real property.

13. A system comprising:
one or more processors;
instructions encoded in one or more tangible media for execution by one or more of the processors and when executed operable to:
(a) receive data pertaining to a subject real property;
(b) receive data pertaining general real property for subsequently determining the quality and the condition of the subject real property;
(c) determine, with general real property data, coefficients on an asset type of the subject real property data;
(d) process the subject real property data along with the coefficients on the asset type of the subject real property data to establish at least one quality model and at least one condition model for the subject real property; and
(e) determine, based on the quality and condition models for the subject real property, a rating for the quality and a rating for the condition of the subject real property.

14. The system of claim 13 wherein said asset type of subject real property is selected from the group of asset types consisting of residential property, agriculture property, industrial property, commercial property, or combinations thereof.

15. The system of claim 13 wherein the instructions when executed are additionally operable to:
sort the subject real property data.

16. The system of claim 13 wherein the instructions when executed
Are additionally operable to:
receive updates on the general real property data.

17. The system of claim 13 wherein the instructions when executed are additionally operable to:
receive improvement data that is unique to the subject real property.

18. The system of claim 13 wherein the instructions when executed are additionally operable to:
display on a screen the rating for the quality and a rating for the condition of the subject real property.
